(19) United States
(12) Patent Application Publication
(10) Pub. No.: US 2009/0223198 A1
(43) Pub. Date: Sep. 10, 2009

(54) MAGNETIC CLEAN UP TOOL

(76) Inventor: Joseph David Nye, Norfolk, VA (US)

Correspondence Address: DUNCAN G. BYERS PC, 142 W. York Street, Suite 910, NORFOLK, VA, 23510, US

(21) Appl. No.: 12/042,407

(22) Filed: Mar. 5, 2008

(51) Int. Cl. A01D 7/10; A47L 13/41; H01F 7/04

(52) U.S. Cl. 56/400.11; 335/285; 335/295; 209/215; 294/65.5

(57) ABSTRACT

A tool for the removal of magnetic debris from worksites. The tool comprises means for the collection and self-removal of magnetic debris from the tool. A magnetic portion resides within a non-magnetic portion and magnetic debris is collected on the exterior of the non-magnetic portion. Removal of the magnetic portion allows collected debris to be removed from the tool. One embodiment of the invention is a rake.

### BACKGROUND OF THE INVENTION

During and after construction and other projects there is a need to clean up the surrounding environment. In new commercial and new residential construction, the surrounding real estate must be restored to a condition where landscaping can begin or the property can be used for its intended purpose, such as a residential yard. In construction projects performed on existing structures, such as repairing a roof, the miscellaneous materials and debris must be removed from the surrounding landscape after the project is done. Even in small projects, such as building a backyard shed, swing set, tree house, or fence, the yard must be cleaned and restored to its original condition to ensure that it may be safely used by others.

The rake is a common tool used to clean the grounds of construction sites. In new construction, where the surrounding real estate is likely dirt and stone, the hard tines of a rake work well to break up the soil and remove some construction debris. On other construction sites, where there may be existing grass or mulch, the rake tines can be used to remove some debris without damaging the landscape. The rake, however, has its shortcomings. The rake's tines often miss small debris, requiring extra work to rake it up. Even worse, if the small debris goes unseen, it will be left there to become a hazard for future users of the property.

Of particular concern is small metal debris (nails, screws, tacks, etc.) that are common to commercial and residential construction sites. Such debris can cause injury to the unwary in a multitude of ways. A person or pet could step on a hidden nail in the grass. Roofing tacks and other sharp metal objects can puncture automobile tires. Lawnmowers and other lawn equipment can eject loose nails or screws causing injury or damage to people, pets, and property. The desire to clean a construction site of hazardous metallic debris is obvious. However, the task of sorting through dirt or grass to find and remove every nail or tack is daunting and cumbersome. Some metal debris will inevitably be left behind.

Various solutions to this problem have been proposed. For example, U.S. Pat. No. 6,669,024 issued to Ottens on Dec. 30, 2003 teaches using a magnet to pick up metal debris. The Ottens patent discloses a hand-held sweeper magnet that is used for extracting magnetic debris from a pick-up surface. The Ottens invention may be effective in some situations, but it does not sufficiently solve the problems discussed above. The use of a magnet alone does not allow for effective clean up at a construction site for at least three reasons. First, though metal debris is centrally the problem, the magnet alone does not function to clean up nonmagnetic debris. It is preferred that most or all debris be removed to effectively clean a construction worksite. A user of the magnet tool as disclosed in Ottens would be required to use a second tool in order to move material and uncover and collect non-metallic debris, thereby having to exert additional effort to finish the job. Second, a magnet cannot pick up metallic debris that is buried beneath dirt, grass, gravel, or other nonmagnetic debris. A second tool is needed to adequately expose the metallic debris for the magnet to collect it. Third, the magnet tool has no means of removing the magnetic debris once it is collected. The user of the invention as taught by Ottens would be required to use an additional tool or their hands to physically remove the magnetic debris (i.e. nails or screws) from the magnet. This is inconvenient and could result in injury.

U.S. Pat. No. 5,408,818 issued to Damron on Apr. 25, 1995 resolves some of these issues, yet is still inadequate for the task at hand. The Damron patent discloses a magnet secured to a rake for the purpose of cleaning up metal debris. The invention taught by Damron combines the usefulness of a rake with the benefits of a magnet to collect and filter out magnetic debris. However, the Damron invention fails to teach or to provide a means to remove the metallic debris from the device once the debris is collected on the magnet portion of the Damron invention. The Damron patent requires that any metal debris that has adhered to the magnet be removed manually; “Once a certain amount of nails are collected to the working surface, the user removes them with a swiping motion.” U.S. Pat. No. 5,408,818, column 2 lines 49-51. Removing nails, screws and other metallic debris attached to a strong magnet in this manner is cumbersome and dangerous (i.e. can lead to injury).

The inadequacies of the prior art have led to the demand for the present invention. The present invention is a tool that allows for metallic debris to be collected at the same time that a site is cleaned or manipulated utilizing a rake or other implement. It effectively collects and retains hazardous metallic debris from dirt, grass, gravel, sand or any other like substance, in combination with a traditional rake or other tool. It can be used to break up and filter through dirt, grass, gravel, sand or other like substances to find and extract hazardous metallic debris. The present invention also provides safe removal of the metallic debris from the tool and, therefore, safe disposal of the hazardous metallic debris.

It will be understood by those skilled in the art that the invention as disclosed below is merely illustrative and that there are other embodiments that are not described herein that still fall within the scope and intent of the present invention. In particular, it will be obvious to one skilled in the art that, although the invention as disclosed herein is combined with a rake, there are a multitude of other tools and implements that may incorporate the present invention and not deviate from the spirit and scope of the present invention. For example, the present invention may be utilized in combination with a shovel, hoe, pitchfork, trowel, or other implements. It will also be understood by those skilled in the art that, while the present invention uses particular examples of the type of debris that is removed from a work site by the present invention, there is no limit to the manner of debris that the present invention may be utilized to collect, so long as the debris or other material is or may be magnetically attracted to the collection surface.

### SUMMARY OF THE PRESENT INVENTION

In a first embodiment of the present invention, the invention comprises of a nonmagnetic tube that may be attached to a tool. For example, FIG. 4 of the drawings shows a nonmagnetic tube attached to a hard-tined rake. It will be understood that the present invention may utilize other attachment means and still remain within the spirit and scope of the present invention, but the embodiment disclosed herein teaches a means of attachment comprising of two studs molded to the body of a nonmagnetic tube. The shape of the tube as disclosed herein should be understood to be illustrative; the tube may comprise an oval, square, triangular, or other shape and still achieve the same purpose. The studs are positioned through the tines of the rake and attached to the tines using fasteners such as wing nuts and sufficiently large washers. A magnet is designed to fit inside the nonmagnetic tube during use. The magnet may comprise a single magnetic body, but smaller magnets configured together may also be utilized and still be within the spirit and scope of the invention. The magnet is secured inside the nonmagnetic tube with a mechanism that will allow for easy removal. The mechanism shown in the embodiment is a spring clip that is physically attached to one end of the magnet as shown in FIGS. 1, 2, and 3. The spring clip secures the magnet inside the nonmagnetic tube during use while also allowing for easy removal of the magnet. While the tool is in use, the magnet will preferentially create sufficient magnetic force to draw and hold magnetic debris to the nonmagnetic tube. Once debris has been collected by the device, the tool can be carried to an appropriate disposal site (i.e. trash can) once the magnet has attracted a sufficient amount of magnetic debris to the nonmagnetic tube. At the disposal site, the magnet is removed from the nonmagnetic tube, allowing the debris to safely fall away from the nonmagnetic tube. The preferred embodiment for this alternative also discloses a partition along one end of the nonmagnetic tube that will block magnetic debris from following the magnet while the magnetic portion is being removed from the nonmagnetic tube. With the magnetic debris released, the magnet can be reinserted and use of the tool can resume.

Another embodiment of the present invention is a tool that comprises of a handle attached to a plurality of hard tines. A nonmagnetic tube is attached to the tines. Again, variations to the means of attachment is understood to be within the spirit and scope of the present invention, but in this embodiment the nonmagnetic tube is attached to the tines of the tool with two threaded studs that are molded to the body of the nonmagnetic tube. The studs are positioned through the tines of the rake and attached to the tines using Easterners such as wing nuts and sufficiently large washers. The nonmagnetic tube is designed to house a magnet. The magnet may be removed and inserted using a lever. The lever runs along the handle of the tool and can be controlled by the user with a lever handle. The lever handle pivots around a pivot pin that is attached to the tool handle at the end opposite the hard tines. The lever is also attached to one end of the magnet. By pushing on the lever handle (or pulling, depending on the location of the lever handle) the magnet will rotate out of the nonmagnetic tube. The nonmagnetic tube and the magnet are designed with consistent curvature so that the magnet will be able to rotate out of the nonmagnetic tube. The curvature of the nonmagnetic tube and the magnet will depend on the length of the lever arm (i.e. the radius of the circle of motion). The normal operating position is when the magnet is inserted in the nonmagnetic tube. The lever arm is secured in the normal operating position by a clipping mechanism. In this position, the nonmagnetic tube will collect magnetic debris since the magnet is inserted within it. The hard tines will function to manipulate dirt, grass, gravel, sand or other such substances while collecting and retaining metallic debris onto the nonmagnetic tube. The metallic debris can easily be disposed by simply pushing the lever handle, which will remove the magnet and demagnetize the nonmagnetic tube. The preferred embodiment for this alternative also discloses a partition along one end of the nonmagnetic tube that will block magnetic debris from following the magnet when it is being removed. Using the lever handle, the magnet can be reinserted after disposal of the metallic debris and use of the tool can resume.

In yet another embodiment of the present invention is a tool that comprises a plurality of hollow tines attached to a handle. The tines in this embodiment function, in part, as the tines of a standard rake. The hollow tines are molded to house a magnet that may be inserted and removed from the tines. The insertion and removal of the magnet is controlled by a lever that is operated along the handle of the tool. When the magnet is inserted inside the tines, which is the normal operating position, and while the tool is being utilized, the magnetic force of the magnet will attract magnetic material to the tines. The tool can be used to manipulate or collect all types of material and debris while at the same time filtering out magnetic debris. The hollow tines are made of a nonmagnetic material, such as a hard plastic or aluminum. The tines can be used to break up and expose magnetic material hidden within dirt, grass, gravel, sand or other such substances while collecting magnetic materials. The tool can then be carried to an appropriate disposal site (i.e. trash can), where the lever can be activated causing the magnetic debris to fall safely away from the tines. The user can then reposition the magnetic assembly within the tines and continue work.

### BRIEF DESCRIPTION OF THE DRAWINGS

FIG. 1 shows a top view, side view, and end view of a nonmagnetic tube with a magnet inserted and secured by a spring clip.

FIG. 2 shows a detailed view of the nonmagnetic tube in FIG. 1 with the magnet partially inserted.

FIG. 3 shows the nonmagnetic tube and the magnet as separate parts.

FIG. 4 shows a magnetic clean up device attached to a hard-tined rake.

FIG. 5 shows a second embodiment of a magnetic clean up tool with the magnet removed.

FIG. 6 shows a cross-sectional view of the magnetic clean up tool from FIG. 5 with the magnet inserted.

FIG. 7 shows a top view of another embodiment of a magnetic clean up tool with a magnet inserted in a nonmagnetic tube

FIG. 8 shows a side view of the magnetic clean up tool from FIG. 7

### DESCRIPTION OF PREFERRED EMBODIMENTS

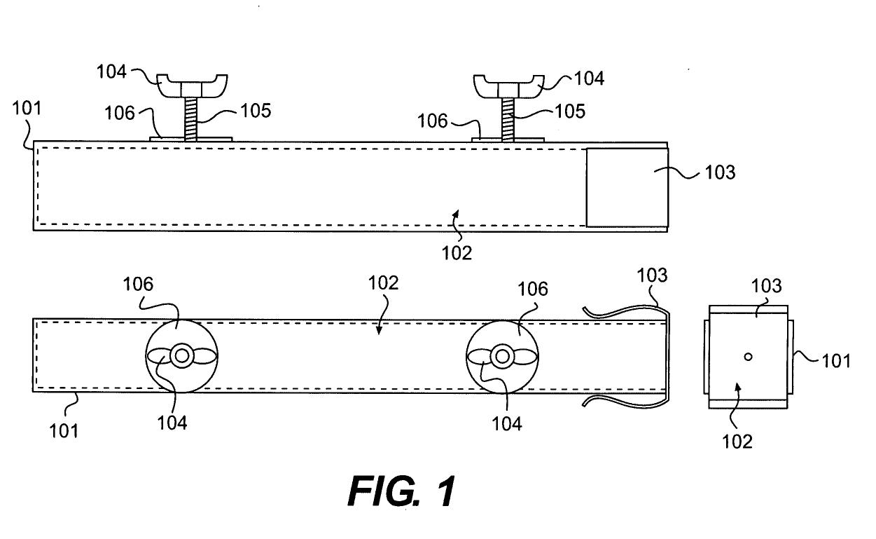

Referring now to FIG. 1, the magnetic clean up device comprises a nonmagnetic tube 101 that has at least two threaded studs 105 attached to and projecting outward from the nonmagnetic tube 101. The studs are made to accept corresponding nuts 104 and washers 106. The nonmagnetic tube 101 is designed to house a magnet 102. The magnet has a spring clip 103 attached to one end which allows the magnet to be held in position within the nonmagnetic tube 101 and also be removed with ease from the nonmagnetic tube 101.

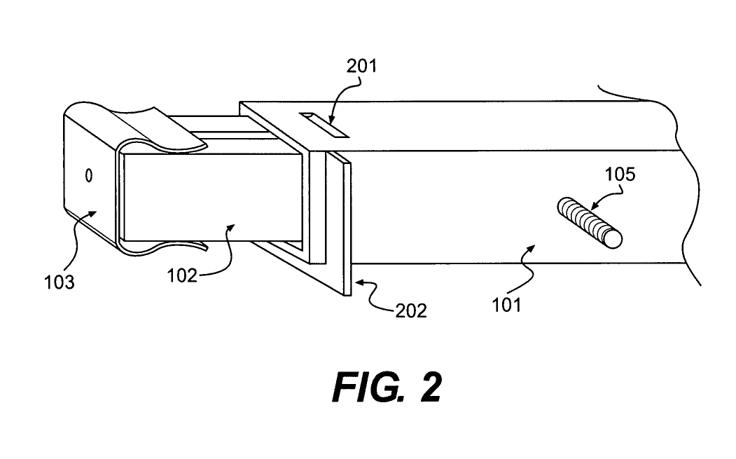

Referring now to FIG. 2, the nonmagnetic tube 101 is made with a depression 201 that corresponds to and accepts the spring clip 103 when the magnet 102 is fully inserted into the nonmagnetic tube 101. The nonmagnetic tube 101 is also made with a nonmagnetic partition 202 on the exterior of the nonmagnetic tube 101 where the nonmagnetic partition 202 is of sufficient length to prevent the metal debris that is collected during use from sliding to the end of the nonmagnetic tube 101 and onto the magnet 102 as the magnet 102 is removed from the nonmagnetic tube 101. This configuration allows a user to safely remove and dispose metal debris by simply removing the magnet 102.

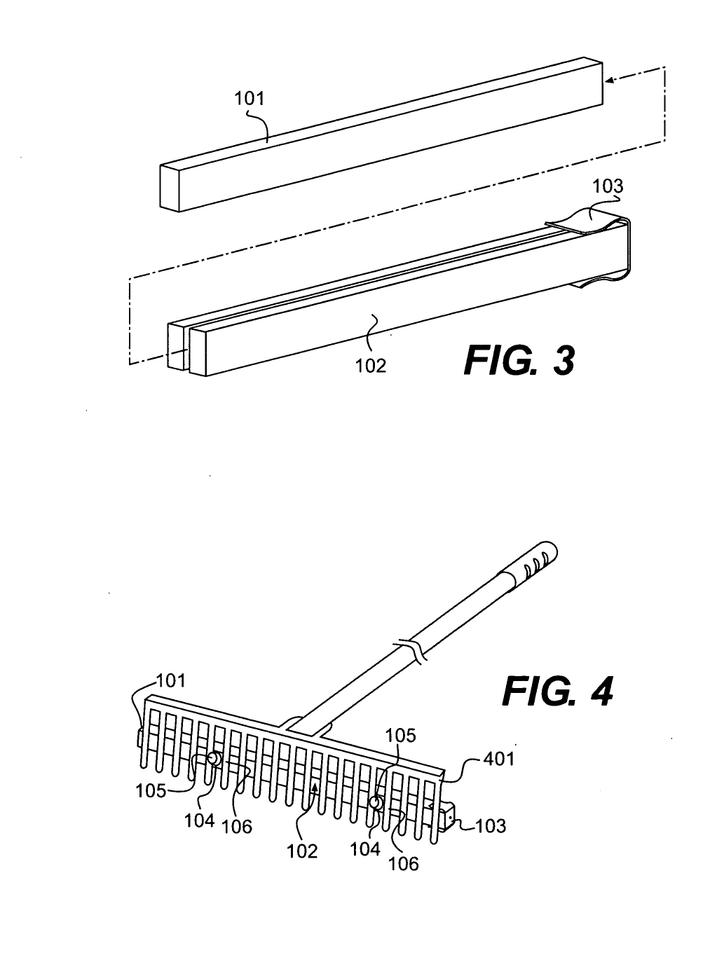

Referring now to FIG. 3, the nonmagnetic tube 101 is a separate part from the magnet 102 and spring clip 103. The spring clip 103 is attached securely to the magnet 102. The spring clip 103 holds the magnet 102 securely in place within the nonmagnetic tube 101 when the magnet 102 is fully inserted into the nonmagnetic tube 101.

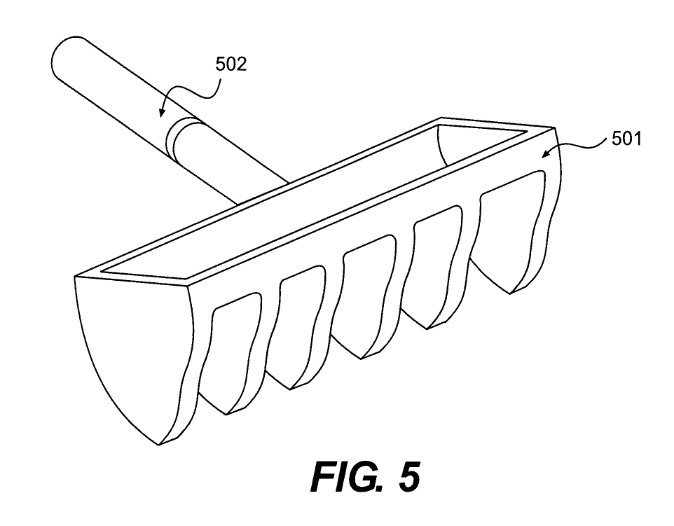

Referring now to FIG. 4, the nonmagnetic tube 101 is attached to the tines 401 of a rake using the nuts 104, the washers 106 and the studs 105. The magnet 102 is shown inserted in the nonmagnetic tube 101 and is secured by the spring clip 103. The rake can now be used in its intended manner while at the same time filtering and collecting hazardous metal debris (i.e. nails, screws, tacks, etc.) that will attach to the surface of the nonmagnetic tube 101. The metal debris can then be safely carried to a trash can or other place of disposal where it can be dropped by simply detaching the spring clip 103 and removing the magnet 102.

FIG. 5 shows a plurality of nonmagnetic, hollow tines 501 of a magnetic clean up tool. The handle 502 is attached to the tines 501 to allow for the tines to be used to collect all types of debris.

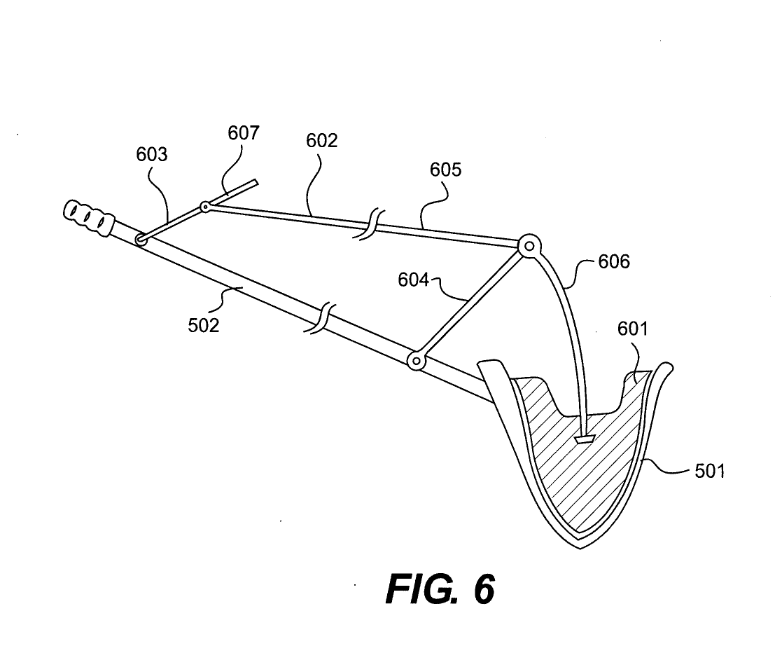

FIG. 6 shows an embodiment of the magnetic clean up tool in the operating position. The magnet 601 is inserted within the hollow tines 501. In this position, the magnetic force of the magnet 601 will cause magnetic debris to attach to the nonmagnetic tines 501. The magnet 601 can be controlled by the lever mechanism 602, which comprises two lever portions 603 and 604 which are hingedly attached to the tool handle 502. The lever portion 603 is hingedly attached to the lever portion 605, and extends in a grasping handle 607 beyond the hinge that connects lever portions 603 and 605. Lever portion 604 hingedly connects to lever portions 605 and 606 at the end of lever portion 604 distal to the tool handle 502. Lever portion 606 is attached to the magnet 601. To operate the tool, a user pulls the lever handle 607 in a direction away from the tines of the tool, causing the magnet 601 to retract out of the hollow tines 501. By so doing, the user can temporarily remove the magnetic forces from the tines 501, allowing the collected magnetic debris to fall from the surface of the tines 501.

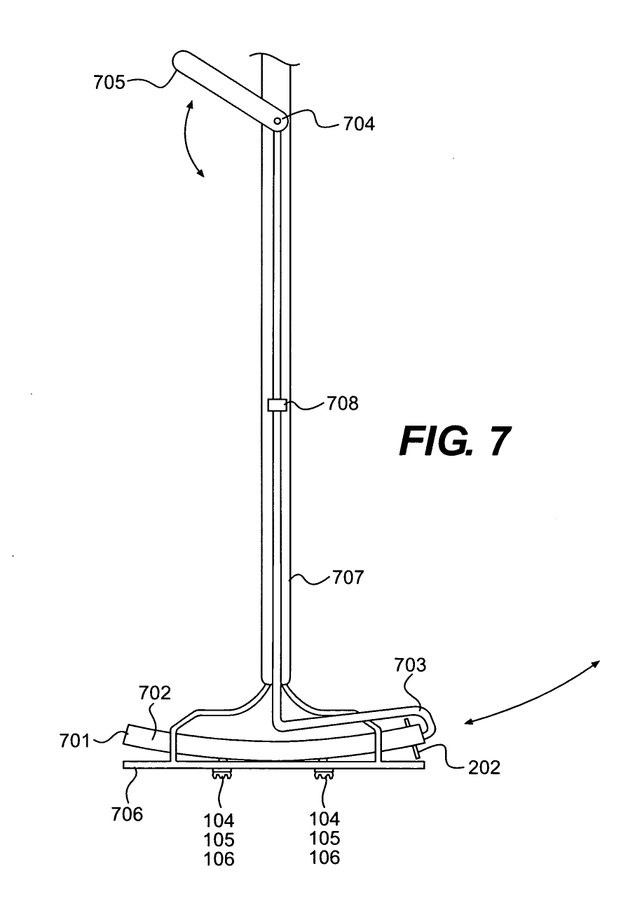

FIG. 7 shows a top view of a lever-controlled magnetic clean up tool. The tool has a handle 707 that is attached to a plurality of hard tines 706. A nonmagnetic tube 701 is attached to the tines 706 running two threaded studs 105 through the tines 706 of the tool. The studs 105 are secured to the tines 706 using wing nuts 104 and washers 106. The nonmagnetic tube 701 is designed to house a magnet 702. FIG. 7 shows the magnet 702 secured within the nonmagnetic tube 701. The magnet 702 is permanently attached to the lever arm 703. The lever arm 703 is attached to the tool handle 707 using a pivot pin 704. The pivot pin 704 is also attached to the lever handle 705. By pushing down on the lever handle 705, the user of the tool causes the magnet 702 to rotate out of the nonmagnetic tube 701. The nonmagnetic tube 701 and the magnet 702 are designed with a curvature that allows the magnet 702 to be inserted and removed from the nonmagnetic tube 701 with the lever arm 703. The curvature of the design corresponds with the length of the lever arm 703 (i.e. the radius of the circle of motion). When the magnet 702 is removed from the nonmagnetic tube 701 the magnetic debris collected on the nonmagnetic tube will fall away from the nonmagnetic tube 701. The nonmagnetic tube 701 is designed with a partition 202 that will act as a shield to prevent magnetic debris from following the magnet 702 when it is removed. In the normal operating position, the magnet 702 will be secured in the nonmagnetic tube 701 and the tines 706 will be used to manipulate dirt, soil, gravel, sand or like substances while collecting magnetic debris onto the nonmagnetic tube 701. The lever arm 703 is held in the operating position by a clipping mechanism 708 which in turn holds the magnet 702 in the operating position. The magnetic debris can be disposed by simply detaching the lever arm 703 from the clipping mechanism 708 and pushing on the lever handle 705 which will remove the magnet 702 from the nonmagnetic tube 701. Once the magnetic debris is disposed of, the lever handle 705 and lever arm 703 can be used to re-insert the magnet 702 back into the nonmagnetic tube 701 and the user can resume use of the tool.

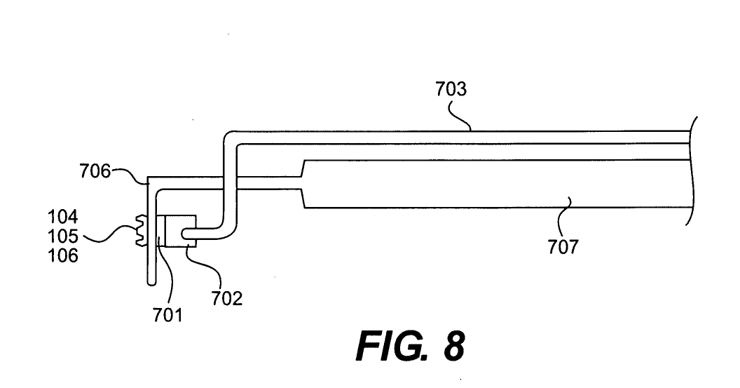

FIG. 8 shows a side view of the magnetic tool in operating position as depicted in FIG. 7. The tines 706 of the tool are connected to the handle 707. The nonmagnetic tube 701 is connected to the tines 706 by running threaded studs 105 through the tines and securing with wing nuts 104 and washers 106. The magnet 702 is shown inserted within the nonmagnetic tube 701. The magnet 702 is permanently connected to the lever arm 703 which is controlled by the lever handle 705 (see FIG. 7) and allows the user of the tool to insert and remove the magnet 702 from the nonmagnetic tube 701.

The invention herein has been described in a manner that is illustrative only, and it will be apparent to one skilled in the art that there are modifications and alterations to the present invention that will not deviate from the scope and spirit of the invention as disclosed herein.

It will be also understood by those skilled in the art that those magnetic materials collected and retained by the present invention are of the class of materials generally defined as materials exhibiting ferromagnetism and ferrimagnetism. However, any material that responds to a magnetic field may be collected and retained utilizing the current invention without deviating from the scope and spirit of the present invention.

It will be further understood by those skilled in the art that, although the invention as described herein relies upon a magnetic field created by those magnets commonly described as “permanent” or “hard” magnets; i.e., materials which retain magnetic fields for long periods of time, it is also contemplated that the magnetic field utilized by the present invention may be created by utilizing electromagnetism; i.e., creating a magnetic field through commonly understood electrical current means. And, those various available means of creating or providing a magnetic field may be utilized individually or in combination and still be within the spirit and scope of the present invention.

I claim:

1. A tool for manipulating and collecting materials, said tool comprising:
a handle;
a plurality of tines attached to said handle; and
collecting means for retaining magnetic materials, said collecting means comprising a non-magnetic portion and a magnetic portion, the said non-magnetic portion comprising a nonmagnetic material and said magnetic portion having a magnetic field.

2. The invention of claim 1 wherein the said collecting means further comprises means for mechanically attaching said collecting means to said plurality of tines.

3. The invention of claim 1 wherein the said non-magnetic portion has a hollow interior portion.

4. The invention of claim 3 wherein the said magnetic portion is insertable within the said hollow portion of said non-magnetic portion.

5. The invention of claim 4 further comprising mechanical means for fixedly attaching said material having a magnetic field within said hollow portion of said nonmagnetic material.

6. The invention of claim 1, wherein the said plurality of tines are comprised of hollow nonmagnetic material.

7. The invention of claim 6, further comprising means for inserting and withdrawing said collecting means from within the interior portion of said plurality of tines.

8. The invention of claim 7, wherein said means for inserting and withdrawing said collecting means comprises a manually-operable handle, a plurality of first connecting means hingedly attached to said manually-operable handle and said collecting means, a plurality of second connecting means hingedly attached to said first connecting means and the said handle of said tool.

9. The invention of claim 1, wherein the said non-magnetic portion comprises a curved non-magnetic tube with a hollow interior portion and said curved non-magnetic tube is attached to said plurality of tines.

10. The invention of claim 9 wherein the said magnetic portion has a curvature corresponding to the curvature of the interior portion of said non-magnetic portion and said second portion is insertable within the said hollow portion of said non-magnetic portion.

11. The invention of claim 10 wherein the said magnetic portion is fixedly attached to a lever arm, a means for restraining said magnetic portion within said non-magnetic portion, and a lever handle, said lever arm and said lever handle hingedly attached to the said handle of said tool at a pivot pin.

12. A device that may be attached to a tool and used to collect, retain and release magnetic debris, the device comprising:
a hollow tube comprised of nonmagnetic material;
means of attaching the hollow tube to a tool; and
a material having a magnetic field that may be inserted and removed from the hollow tube.

13. The invention of claim 10, wherein the material having a magnetic field further comprises a restraining mechanism, said restraining mechanism fixedly attaching said magnetic portion within said hollow portion.

14. The invention of claim 11, wherein the nonmagnetic tube comprises a depression to accept the spring clip.

15. The invention of claim 12, further comprising a raised portion on said nonmagnetic tube and wherein said raised portion is comprised of nonmagnetic material, said raised portion restricting movement of magnetic debris laterally on said nonmagnetic tube.

16. A tool that is used to manipulate and clean debris out of grass, soil, dirt, gravel, sand and the like while also collecting and retaining magnetic debris, the tool comprising:
a tool handle;
a plurality of hard tines that are attached to the tool handle and controlled by the tool handle to manipulate and clean debris out of grass, soil, dirt, gravel, sand and the like;
a nonmagnetic tube;
means of attaching the nonmagnetic tube to the tines;
a magnet that is designed to fit inside the nonmagnetic tube;
a lever mechanism that controls the insertion and removal of the magnet from the nonmagnetic tube.

17. The invention of claim 9, wherein the nonmagnetic tube comprises a nonmagnetic partition attached externally to one end so as to prevent the magnetic debris from following the magnet as it is removed.

18. The invention of claim 9, wherein the lever mechanism further comprises a lever handle that is used to control the insertion and removal of the magnet and further comprises a lever arm that is attached to the magnet.

19. The invention of claim 11, wherein the lever mechanism further comprises a pivot that is attached to the tool handle at the end opposite the plurality of tines.

20. The invention of claim 11, wherein the tool handle further comprises means for secureing the lever arm in a vertical position.

21. The invention of claim 11 wherein the said magnetic portion has a curvature corresponding to the curvature of the interior portion of said non-magnetic portion and said second portion is insertable within the said hollow portion of said non-magnetic portion.
